(19) United States
(12) Patent Application Publication
(10) Pub. No.: US 2014/0360786 A1
(43) Pub. Date: Dec. 11, 2014

(54) Lubricants for Oil-Based and Water-Based Fluids for Use in Subterranean Formation Operations

(71) Applicant: Halliburton Energy Services, Inc., Houston, TX (US)

(72) Inventors: Cato McDaniel, Houston, TX (US); Dale E. Jamison, Houston, TX (US)

(21) Appl. No.: 13/912,690

(22) Filed: Jun. 7, 2013

(51) Int. Cl. C09K 8/03

(52) U.S. Cl. CPC C09K 8/032
USPC 175/65; 507/140

(57) ABSTRACT

Methods of treatment subterranean formations including providing a treatment fluid comprising a base fluid and a lubricating agent, wherein the lubricating agent is selected from the group consisting of bismuth dialkyl dithiophosphate; tungsten disulfide; a mixture of micronized graphite and micronized metal disulfide; and any combination thereof; and introducing the treatment fluid into a wellbore in the subterranean formation.

### BACKGROUND

The present invention relates to lubricants for oil-based and water-based fluids for use in subterranean formation operations.

During subterranean formation operations, treatment fluids are often pumped or circulated through equipment at high temperature and high pressure velocities, which may result in damage to the equipment. For example, during the drilling of a subterranean formation wellbore (e.g., an oil or gas wellbore), a drill bit may be attached at the end of a rotating drill string. The drill bit is used to penetrate the formation while a treatment fluid is circulated through the drill string and out of the drill bit. The treatment fluid serves multiple purposes, such as cooling and lubricating the drill string and drill bit, counterbalancing formation pressures, removing drill cuttings, and the like. During drilling, the gears, bearings, or other metal-to-metal contact areas are preferably lubricated to prevent the metal-to-metal areas from abrasive contact. When the lubricant fails to prevent such contact, particularly in high temperature and high pressure environments, localized welding of the equipment may occur, deforming equipment and potentially causing a substantial drain on resources owed to equipment repair or replacement and/or operational downtime.

Thus, a lubricant that may prolong the life of operational equipment. Traditionally, such lubricants have been either self-contained lubricating agents housed within the equipment itself or added to a base fluid to produce a treatment fluid capable of imparting lubricating properties to the base fluid. Traditional lubricants for use in subterranean operations include sulfides and disulfides of lead, arsenic, antimony, bismuth, zinc, iron, cadmium, copper, molybdenum, and mercury. Traditional lubricants also include zinc dialkyl dithiophosphate. These traditional lubricants may be environmentally unpreferred or may be inadequate for extended use as a lubricant alone. Therefore, improved treatment fluids comprising lubricating agents for use during subterranean operations may be of benefit to one of ordinary skill in the art.

### SUMMARY OF THE INVENTION

The present invention relates to lubricants for oil-based and water-based fluids for use in subterranean formation operations.

In some embodiments, the present invention provides a method comprising: providing a treatment fluid comprising a base fluid and a lubricating agent, wherein the lubricating agent is selected from the group consisting of bismuth dialkyl dithiophosphate; tungsten disulfide; a mixture of micronized graphite and micronized metal disulfide; and any combination thereof; and introducing the treatment fluid into a wellbore in a subterranean formation.

In other embodiments, the present invention provides a method of drilling a wellbore in a subterranean formation comprising: providing a treatment fluid comprising a base fluid and a lubricating agent, wherein the lubricating agent is selected from the group consisting of bismuth dialkyl dithiophosphate; tungsten disulfide; a mixture of micronized graphite and micronized metal disulfide; and any combination thereof; and circulating the treatment fluid during the drilling of the wellbore in the subterranean formation.

In still other embodiments, the present invention provides a lubricant composition comprising: a base fluid; and a lubricating agent selected from the group consisting of bismuth dialkyl dithiophosphate; tungsten disulfide; a mixture of micronized graphite and micronized metal disulfide; and any combination thereof.

The features and advantages of the present invention will be readily apparent to those skilled in the art upon a reading of the description of the preferred embodiments that follows.

### BRIEF DESCRIPTION OF THE DRAWINGS

The following figures are included to illustrate certain aspects of the present invention, and should not be viewed as exclusive embodiments. The subject matter disclosed is capable of considerable modifications, alterations, combinations, and equivalents in form and function, as will occur to those skilled in the art and having the benefit of this disclosure.

FIG. 1 is a side view of a wellbore drilling assembly with which the lubricating agents of the present invention may be used.

### DETAILED DESCRIPTION

The present invention relates to lubricants for oil-based and water-based fluids for use in subterranean formation operations.

The methods and compositions of the present invention are directed toward treatment fluids that employ novel lubricating agents in a base fluid for use in subterranean operations, such as drilling operations. While drilling fluids may be specifically referred to herein for illustration, the lubricants of the present invention may be used in any subterranean formation operation that employs a fluid and that may benefit from a lubricating agent. Such operations may include, but are not limited to, completion operations, workover operations, fracturing operations, frac-packing operations, and the like.

Subterranean formation operations, particularly those performed at high temperatures and high pressures and/or in extended horizontal wells, benefit substantially from fluids with increased lubricity, thereby reducing the friction of the fluids against the wellbore and associated operational equipment. The novel lubricating agents for use in the methods and compositions of the present invention may be selected from the group consisting of: bismuth dialkyl dithophosphate; tungsten disulfide; a mixture of micronized graphite and micronized metal disulfide; and combinations thereof.

In some embodiments, the lubricating agent of the present invention is a liquid bismuth dialkyl dithiophosphate. Bismuth dialkyl dithiophosphate is a relatively inert and non-toxic compound that may eliminate or reduce environmental and/or toxicity concerns that surround the use of some traditional lubricating agents. Additionally, a treatment fluid comprising bismuth dialkyl dithiophosphate may beneficially enhance the action of other lubricating agents, such as those disclosed herein, and may increase the rate of penetration during drilling. As used herein, the term “rate of penetration” refers to the speed at which a drill bit can break the subterranean formation beneath it and deepen a wellbore. Bismuth dialkyl dithiophosphate is oil soluble, but may be soluble in water-base fluids in an amount sufficient to increase the lubricity of a water-based fluid in accordance with the teachings of the present invention. The bismuth dialkyl dithiophosphate lubricating agent may additionally be used in oil-in-water or water-in-oil emulsions.

In some embodiments, the methods and compositions of the present invention may employ a solid lubricating agent of tungsten disulfide or a mixture of micronized graphite and micronized metal disulfide. These solid lubricating agents may also beneficially increase the lubricity of an oil-based fluid, a water-based fluid, or an emulsion. Additionally, the solid lubricating agents of the present invention may beneficially serve a dual function as a lubricating agent and a weighting agent.

Tungsten disulfide is highly lubricous under extreme conditions of pressure and temperature. Tungsten disulfide has a particularly low coefficient of friction and an operational temperature ranging from atmospheric temperatures of about −273° C. to about 650° C. Additionally, a tungsten disulfide lubricating agent may provide added lubricity benefits over previously known and used lubricating agents owing to its shape. The tungsten disulfide lubricating agents disclosed herein may be generally flat or disc-shaped, enhancing their suspension and their lubricious qualities, as they may more easily conform to the internal dimensions of operational equipment, for example. In some embodiments, the tungsten disulfide may be micronized for use as a lubricating agent. As used herein, the term “micronized” refers to reducing the size of particles such that they have an effective diameter of about 0.01 micron to about 100 microns.

In certain embodiments of the present invention, the lubricating agent may be a mixture of micronized graphite and micronized metal disulfide. In these embodiments, the use of micronized graphite may allow a decrease in the amount of micronized metal disulfide necessary to achieve the desired lubricity effects, thus limiting any potential environmental or toxicity concerns that may be attributed to the particular micronized metal disulfide used, as well as cost concerns. Suitable metal disulfides include, but are not limited to, tungsten disulfide; molybdenum disulfide; bismuth disulfide; lead disulfide; arsenic disulfide; zinc disulfide; iron disulfide; cadmium disulfide; copper disulfide; mercury disulfide; and any combination thereof. In preferred embodiments, the metal disulfide for use in the lubricating agents of the present invention are selected from the group consisting of tungsten disulfide; molybdenum disulfide; bismuth disulfide; iron disulfide; cadmium disulfide; and any combination thereof. Generally, the metal micronized disulfide will be more lubricious than the micronized graphite and, thus, it is preferred that the mixture of micronized graphite and micronized metal disulfide comprise a greater amount of micronized metal disulfide than micronized graphite. In some embodiments, the micronized graphite and micronized metal disulfide are present in an amount of about 1:100 to about 1:1 in the treatment fluid. This includes ranging from a lower limit of 1:100, 1:90, 1:80, 1:70, 1:60, 1:50, 1:40, 1:30, or 1:20 to an upper limit of 1:1, 1:2, 1:5, 1:10, 1:20, 1:30, 1:40, and 1:50.

The solid lubricating agents of the present invention may range in size from about 0.01 micron in diameter to about 2000 microns in diameter. In preferred embodiments, the solid lubricating agents of the present invention may be micronized such that they have a size range of about 0.01 micron in diameter to about 1000 microns in diameter. In more preferred embodiments, the solid lubricating agents of the present invention have a size range of about 0.04 microns in diameter to about 50 microns in diameter. The micronized lubricating agents may advantageously reduce treatment fluid consumption during subterranean operations, exhibit superior suspension capabilities within the treatment fluid such that sedimentation does not reduce or prevent the lubricating agents from performing properly, improve ease of mixing of the treatment fluid, and/or provide enhanced lubricity due to their ability to penetrate tight spaces (e.g., very small gaps between metal surfaces in drilling equipment). One of ordinary skill in the art, with the benefit of this disclosure, will recognize the appropriate size of the solid lubricating agents of the present invention to include in a treatment fluid to perform a specific subterranean operation.

If required, micronization of the solid lubricating agents of the present invention may be achieved by any means known in the art. For example, micronization may be achieved in a pinned-disk mill; a steam-jet mill; an air-jet mill; a ball mill; a grinding dryer; or any combination thereof. Additionally, the micronization may be achieved as a wet procedure or a dry procedure. If a wet micronization procedure is used, the micronization may occur in the presence of an aqueous fluid and/or a suitable salt or dispersing agent.

In some embodiments, the lubricating agents of the present invention, whether in liquid or solid form, may be present in a concentration of about 0.0258 kg/m³ to about 114.12 kg/m³ of the treatment fluid (about 0.01 pounds per barrel (ppb) to about 40 ppb). In some embodiments, the lubricating agents of the present invention, whether in liquid or solid form, may be present in a concentration of about 0.285 kg/m3 to about 57.06 kg/m3 of the treatment fluid (about 0.1 ppb to about 20 ppb).

The lubricating agents of the present invention may reduce the coefficient of friction of the treatment fluids in which they are introduced, as compared to the treatment fluid without the lubricating agent. The amount of the reduction of the coefficient of friction of the treatment fluid comprising the lubricating agent may depend on a number of factors including the type of treatment fluid use, the type of lubricating agent used, the subterranean conditions into which the treatment fluid is introduced, and the like. In some embodiments, the lubricating agents may reduce the coefficient of friction of the treatment fluid to come into agreement with the coefficient of friction of the lubricating agent itself. In some embodiments, the coefficient of friction of the treatment fluids containing the lubricating agent may be in the range of from about 0.4 to about 0.01.

The lubricating agents of the present invention may be present in any base fluid capable of use in a subterranean operation. Suitable base fluids for use in conjunction with the present invention may include, but are not limited to, oil-base fluids; water-based fluid; water-in-oil emulsions; or oil-in-water emulsions. Suitable oil-base fluids may include, but are not limited to, alkanes; olefins; aromatic organic compounds; cyclic alkanes; paraffins; diesel fluids; mineral oils; desulfurized hydrogenated kerosenes; and any combination thereof. Suitable water-base fluids may include, but are not limited to, fresh water; saltwater (e.g., water containing one or more salts dissolved therein); brine (e.g., saturated salt water); seawater; and any combination thereof. Suitable water-in-oil emulsions, also known as invert emulsions, may have an oil-to-water ratio from a lower limit of greater than about 50:50, 55:45, 60:40, 65:35, 70:30, 75:25, or 80:20 to an upper limit of less than about 100:0, 95:5, 90:10, 85:15, 80:20, 75:25, 70:30, or 65:35 by volume in the base fluid, where the amount may range from any lower limit to any upper limit and encompass any subset therebetween. Examples of suitable invert emulsions include those disclosed in U.S. Pat. Nos. 5,905,061; 5,977,031; 6,828,279; 7,534,745; 7,645,723; and 7,696,131, each of which are incorporated herein by reference in their entirety. It should be noted that for water-in-oil and oil-in-water emulsions, any mixture of the above may be used.

The treatment fluids of the present invention may further comprise an additive appropriate for the particular subterranean operation for which the treatment fluid is to be used. Suitable additives include, but are not limited to, a salt; a weighting agent; an inert solid; a fluid loss control agent; an emulsifier; a dispersion aid; a corrosion inhibitor; an emulsion thinner; an emulsion thickener; a viscosifying agent; a gelling agent; a surfactant; a particulate; a proppant; a gravel particulate; a lost circulation material; a foaming agent; a gas; a pH control additive; a breaker; a biocide; a crosslinker; a scale inhibitor; a clay stabilizing agent; and any combination thereof.

Embodiments disclosed herein include:

A. A method comprising providing a treatment fluid comprising a base fluid and a lubricating agent, wherein the lubricating agent is selected from the group consisting of bismuth dialkyl dithiophosphate; tungsten disulfide; a mixture of micronized graphite and micronized metal disulfide; and any combination thereof; and introducing the treatment fluid into a wellbore in a subterranean formation.

B. A method of drilling a wellbore in a subterranean formation comprising: providing a treatment fluid comprising a base fluid and a lubricating agent, wherein the lubricating agent is selected from the group consisting of bismuth dialkyl dithiophosphate; tungsten disulfide; a mixture of micronized graphite and micronized metal disulfide; and any combination thereof; and circulating the treatment fluid during the drilling of the wellbore in the subterranean formation.

C. A lubricant composition comprising: a base fluid; and a lubricating agent selected from the group consisting of bismuth dialkyl dithiophosphate; tungsten disulfide; a mixture of micronized graphite and micronized metal disulfide; and any combination thereof.

Each of embodiments A, B, and C may have one or more of the following additional elements in any combination:

Element 1: Wherein the lubricating agent is tungsten disulfide and wherein the tungsten disulfide is micronized.

Element 2: Wherein the lubricating agent is tungsten disulfide or the mixture of micronized graphite and micronized bismuth dialkyl dithiophosphate and wherein the lubricating agent further functions as a weighting agent.

Element 3: Wherein the lubricating agent is the mixture of micronized graphite and micronized metal disulfide and wherein the micronized metal disulfide is selected from the group consisting of tungsten disulfide; molybdenum disulfide; bismuth disulfide; lead disulfide; arsenic disulfide; zinc disulfide; iron disulfide; cadmium disulfide; copper disulfide; mercury disulfide; and any combination thereof.

Element 4: Wherein the lubricating agent is present in a concentration of about 0.0258 kg/m³ to about 114.12 kg/m³ of the treatment fluid.

Element 5: Wherein the lubricating agent reduces the coefficient of friction of the treatment fluid as compared to the treatment fluid without the lubricating agent.

Element 6: Wherein the lubricating agent is tungsten disulfide that is micronized and has a diameter of from about 0.01 micron to about 100 microns.

Element 7: Wherein the lubricating agent is tungsten disulfide and has a diameter of from about 0.01 micron to about 2000 microns.

Element 8: Wherein the lubricating agent is the mixture of micronized graphite and micronized metal disulfide and wherein the micronized graphite and the micronized metal disulfide have a diameter of from about 0.01 micron to about 100 microns.

By way of non-limiting example, exemplary combinations applicable to A, B, C include: A in combination with 6; A in combination with 7; A in combination with 8; B in combination with 1; B in combination with 6 and 8; B in combination with 7; C in combination with 1, 2, and 4; C in combination with 4 and 8.

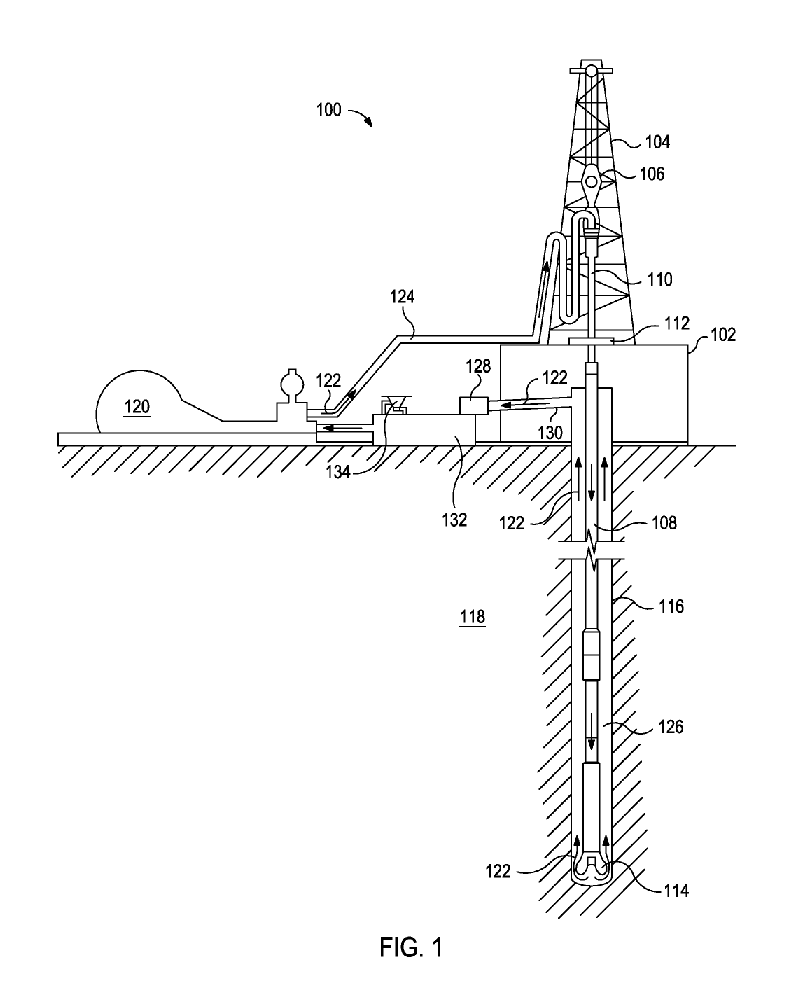

The exemplary lubricating agents disclosed herein may directly or indirectly affect one or more components or pieces of equipment associated with the preparation, delivery, recapture, recycling, reuse, and/or disposal of the disclosed lubricating agents. For example, and with reference to FIG. 1, the disclosed lubricating agents may directly or indirectly affect one or more components or pieces of equipment associated with an exemplary wellbore drilling assembly 100, according to one or more embodiments. It should be noted that while FIG. 1 generally depicts a land-based drilling assembly, those skilled in the art will readily recognize that the principles described herein are equally applicable to subsea drilling operations that employ floating or sea-based platforms and rigs, without departing from the scope of the disclosure.

As illustrated, the drilling assembly 100 may include a drilling platform 102 that supports a derrick 104 having a traveling block 106 for raising and lowering a drill string 108. The drill string 108 may include, but is not limited to, drill pipe and coiled tubing, as generally known to those skilled in the art. A kelly 110 supports the drill string 108 as it is lowered through a rotary table 112. A drill bit 114 is attached to the distal end of the drill string 108 and is driven either by a downhole motor and/or via rotation of the drill string 108 from the well surface. As the bit 114 rotates, it creates a borehole 116 that penetrates various subterranean formations 118.

A pump 120 (e.g., a mud pump) circulates drilling fluid 122 through a feed pipe 124 and to the kelly 110, which conveys the drilling fluid 122 downhole through the interior of the drill string 108 and through one or more orifices in the drill bit 114. The drilling fluid 122 is then circulated back to the surface via an annulus 126 defined between the drill string 108 and the walls of the borehole 116. At the surface, the recirculated or spent drilling fluid 122 exits the annulus 126 and may be conveyed to one or more fluid processing unit(s) 128 via an interconnecting flow line 130. After passing through the fluid processing unit(s) 128, a “cleaned” drilling fluid 122 is deposited into a nearby retention pit 132 (i.e., a mud pit). While illustrated as being arranged at the outlet of the wellbore 116 via the annulus 126, those skilled in the art will readily appreciate that the fluid processing unit(s) 128 may be arranged at any other location in the drilling assembly 100 to facilitate its proper function, without departing from the scope of the scope of the disclosure.

One or more of the disclosed lubricating agents may be added to the drilling fluid 122 via a mixing hopper 134 communicably coupled to or otherwise in fluid communication with the retention pit 132. The mixing hopper 134 may include, but is not limited to, mixers and related mixing equipment known to those skilled in the art. In other embodiments, however, the disclosed lubricating agents may be added to the drilling fluid 122 at any other location in the drilling assembly 100. In at least one embodiment, for example, there could be more than one retention pit 132, such as multiple retention pits 132 in series. Moreover, the retention pit 132 may be representative of one or more fluid storage facilities and/or units where the disclosed lubricating agents may be stored, reconditioned, and/or regulated until added to the drilling fluid 122.

As mentioned above, the disclosed lubricating agents may directly or indirectly affect the components and equipment of the drilling assembly 100. For example, the disclosed lubricating agents may directly or indirectly affect the fluid processing unit(s) 128 which may include, but is not limited to, one or more of a shaker (e.g., shale shaker), a centrifuge, a hydrocyclone, a separator (including magnetic and electrical separators), a desilter, a desander, a separator, a filter (e.g., diatomaceous earth filters), a heat exchanger, or any fluid reclamation equipment. The fluid processing unit(s) 128 may further include one or more sensors, gauges, pumps, compressors, and the like used store, monitor, regulate, and/or recondition the exemplary lubricating agents.

The disclosed lubricating agents may directly or indirectly affect the pump 120, which representatively includes any conduits, pipelines, trucks, tubulars, and/or pipes used to fluidically convey the lubricating agents downhole, any pumps, compressors, or motors (e.g., topside or downhole) used to drive the lubricating agents into motion, any valves or related joints used to regulate the pressure or flow rate of the lubricating agents, and any sensors (i.e., pressure, temperature, flow rate, etc.), gauges, and/or combinations thereof, and the like. The disclosed lubricating agents may also directly or indirectly affect the mixing hopper 134 and the retention pit 132 and their assorted variations.

The disclosed lubricating agents may also directly or indirectly affect the various downhole equipment and tools that may come into contact with the lubricating agents such as, but not limited to, the drill string 108, any floats, drill collars, mud motors, downhole motors and/or pumps associated with the drill string 108, and any MWD/LWD tools and related telemetry equipment, sensors or distributed sensors associated with the drill string 108. The disclosed lubricating agents may also directly or indirectly affect any downhole heat exchangers, valves and corresponding actuation devices, tool seals, packers and other wellbore isolation devices or components, and the like associated with the wellbore 116. The disclosed lubricating agents may also directly or indirectly affect the drill bit 114, which may include, but is not limited to, roller cone bits, PDC bits, natural diamond bits, any hole openers, reamers, coring bits, etc.

While not specifically illustrated herein, the disclosed lubricating agents may also directly or indirectly affect any transport or delivery equipment used to convey the lubricating agents to the drilling assembly 100 such as, for example, any transport vessels, conduits, pipelines, trucks, tubulars, and/or pipes used to fluidically move the lubricating agents from one location to another, any pumps, compressors, or motors used to drive the lubricating agents into motion, any valves or related joints used to regulate the pressure or flow rate of the lubricating agents, and any sensors (i.e., pressure and temperature), gauges, and/or combinations thereof, and the like.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present invention. The invention illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces. If there is any conflict in the usages of a word or term in this specification and one or more patent or other documents that may be incorporated herein by reference, the definitions that are consistent with this specification should be adopted.

The invention claimed is:

1. A method comprising:
providing a treatment fluid comprising a base fluid and a lubricating agent,
wherein the lubricating agent is selected from the group consisting of bismuth dialkyl dithiophosphate; tungsten disulfide; a mixture of micronized graphite and micronized metal disulfide; and any combination thereof; and
introducing the treatment fluid into a wellbore in a subterranean formation.

2. The method of claim 1, wherein the lubricating agent is tungsten disulfide and wherein the tungsten disulfide is micronized.

3. The method of claim 1, wherein the lubricating agent is tungsten disulfide or the mixture of micronized graphite and micronized bismuth dialkyl dithiophosphate and wherein the lubricating agent further functions as a weighting agent.

4. The method of claim 1, wherein the lubricating agent is the mixture of micronized graphite and micronized metal disulfide and wherein the micronized metal disulfide is selected from the group consisting of tungsten disulfide; molybdenum disulfide; bismuth disulfide; lead disulfide; arsenic disulfide; zinc disulfide; iron disulfide; cadmium disulfide; copper disulfide; mercury disulfide; and any combination thereof.

5. The method of claim 1, wherein the lubricating agent is present in a concentration of about 0.0258 kg/m³ to about 114.12 kg/m³ of the treatment fluid.

6. The method of claim 1, wherein the lubricating agent reduces the coefficient of friction of the treatment fluid as compared to the treatment fluid without the lubricating agent.

7. A method of drilling a wellbore in a subterranean formation comprising:
providing a treatment fluid comprising a base fluid and a lubricating agent,
wherein the lubricating agent is selected from the group consisting of bismuth dialkyl dithiophosphate; tungsten disulfide; a mixture of micronized graphite and micronized metal disulfide; and any combination thereof; and
circulating the treatment fluid during the drilling of the wellbore in the subterranean formation.

8. The method of claim 7, wherein the lubricating agent is tungsten disulfide or the mixture of micronized graphite and micronized bismuth dialkyl dithiophosphate and wherein the lubricating agent further functions as a weighting agent.

9. The method of claim 7, wherein the lubricating agent is the mixture of micronized graphite and micronized metal disulfide and wherein the micronized metal disulfide is selected from the group consisting of tungsten disulfide; molybdenum disulfide; bismuth disulfide; lead disulfide; arsenic disulfide; zinc disulfide; iron disulfide; cadmium disulfide; copper disulfide; mercury disulfide; and any combination thereof.

10. The method of claim 7, wherein the lubricating agent is present in a concentration of about 0.0258 kg/m³ to about 114.12 kg/m³ of the treatment fluid.

11. The method of claim 7, wherein the lubricating agent reduces the coefficient of friction of the treatment fluid as compared to the treatment fluid without the lubricating agent.

12. A lubricant composition comprising:
a base fluid; and
a lubricating agent selected from the group consisting of bismuth dialkyl dithiophosphate; tungsten disulfide; a mixture of micronized graphite and micronized metal disulfide; and any combination thereof.

13. The method of claim 12, wherein the lubricating agent is tungsten disulfide and has a diameter of from about 0.01 micron to about 2000 microns.

14. The method of claim 12, wherein the lubricating agent is tungsten disulfide and wherein the tungsten disulfide is micronized.

15. The method of claim 14, wherein the tungsten disulfide that is micronized has a diameter of from about 0.01 micron to about 100 microns.

16. The method of claim 12, wherein the lubricating agent is tungsten disulfide or the mixture of micronized graphite and micronized bismuth dialkyl dithiophosphate and wherein the lubricating agent further functions as a weighting agent.

17. The method of claim 12, wherein the lubricating agent is the mixture of micronized graphite and micronized metal disulfide and wherein the micronized metal disulfide is selected from the group consisting of tungsten disulfide; molybdenum disulfide; bismuth disulfide; lead disulfide; arsenic disulfide; zinc disulfide; iron disulfide; cadmium disulfide; copper disulfide; mercury disulfide; and any combination thereof.

18. The method of claim 12, wherein the lubricating agent is the mixture of micronized graphite and micronized metal disulfide and wherein the micronized graphite and the micronized metal disulfide have a diameter of from about 0.01 micron to about 100 microns.

19. The method of claim 12, wherein the lubricating agent is present in a concentration of about 0.0258 kg/m³ to about 114.12 kg/m³ of the treatment fluid.

20. The method of claim 12, wherein the lubricating agent reduces the coefficient of friction of the treatment fluid as compared to the treatment fluid without the lubricating agent.
